(19) United States
(12) Patent Application Publication
(10) Pub. No.: US 2025/0007346 A1
(43) Pub. Date: Jan. 2, 2025

(54) STATOR FOR AN ELECTRICAL MACHINE AND ELECTRICAL MACHINE

(71) Applicant: Valeo eAutomotive Germany GmbH, Erlangen (DE)

(72) Inventors: Dotz BORIS, Bad Neustadt a.d.Saale (DE); Christian FINGER-ALBERT, Bad Neustadt a.d.Saale (DE)

(73) Assignee: Valeo eAutomotive Germany GmbH, Erlangen (DE)

(21) Appl. No.: 18/694,535

(22) PCT Filed: Sep. 15, 2022
(86) PCT No.: PCT/EP2022/075693

§ 371 Date: Mar. 22, 2024

(30) Foreign Application Priority Data
Sep. 22, 2021 (EP) 21198319.2

(51) Int. Cl. H02K 3/28

(52) U.S. Cl. CPC H02K 3/28

(57) ABSTRACT

A stator for an electrical machine includes a stator core in which a plurality of grooves distributed in a circumferential direction are formed and which has two opposite end faces, and a stator winding having a plurality of shaped conductors. The shaped conductors each have a first leg portion, a second leg portion and a head portion connecting the leg portions to one of the end faces. The leg portions extend through different grooves and are spaced apart from one another by an increment of a number of grooves.

The invention relates to a stator for an electrical machine, comprising a stator core in which are formed a multiplicity of grooves that are distributed along a circumferential direction, and which has two end sides that are mutually opposite in an axial direction, and a stator winding that has a multiplicity of shaped conductors, wherein the shaped conductors have in each case one first leg portion, one second leg portion and one head portion which connects the leg portions in an electrically conductive manner on one of the end sides; wherein the leg portions of a respective shaped conductor extend through different grooves and are spaced apart from one another by an increment of a number of grooves; wherein the head portion has an inner portion which extends in the circumferential direction and adjoins the first leg portion, and an outer portion which extends in the circumferential direction, adjoins the second leg portion and is disposed further radially outside than the inner portion; wherein the increment in a first and a second of the shaped conductors is S, in a third of the shaped conductors is at least one greater than S, and in a fourth of the shaped conductors is at least one smaller than S, where S is a natural number.

Moreover, the invention relates to an electrical machine.

Known from DE 11 2019 004 037 T5 is a stator for an electrical machine, comprising a stator body which supports a plurality of windings. The stator body comprises a plurality of slots. A conductor of the winding forms end windings which have bends with a first winding increment, a second winding increment and a third winding increment. The second winding increment is one greater than the first winding increment. The third winding increment is one smaller than the first winding increment.

In stators with a stator winding made of shaped conductors, the head portions thereof having different increments, these head portions must be mutually disposed in a suitable manner. For example, a small axial winding overhang is desired on the end side where the head portions are located. Similarly, the disposal of the shaped conductors in the stator core should be simple in terms of production.

The invention is based on the object to provide an improved possibility for disposing shaped conductors of a stator winding with different increments.

In a stator of the type mentioned above this object is achieved according to the invention in that the head portion furthermore has an offset portion which connects the inner portion to the outer portion and has a greater radial extent than the inner portion and the outer portion, and that the outer portion of the head portion of the third shaped conductor runs at least partially radially further outward than the outer portions of the head portions of the first, the second and the fourth shaped conductor.

The stator according to the invention for an electrical machine has a stator core. A multiplicity of grooves are formed in the stator core. The grooves are distributed along a circumferential direction. The stator core has two end sides. The end sides are mutually opposite in an axial direction. The stator furthermore has a stator winding. The stator winding has a multiplicity of shaped conductors. The shaped conductors have in each case one first leg portion, one second leg portion and one head portion. The head portion connects the leg portions in an electrically conductive manner on one of the end sides. The leg portions of a respective shaped conductor extend through different grooves. The leg portions of a respective shaped conductor are spaced apart from one another by an increment of a number of grooves. The head portion has an inner portion. The inner portion extends in the circumferential direction. The inner portion adjoins the first leg portion. The head portion has an outer portion. The outer portion extends in the circumferential direction. The outer portion adjoins the second leg portion. The outer portion is disposed radially further outward than the inner portion. The increment in a first and a second of the shaped conductors is S. S is a natural number. In a third of the shaped conductors, the increment is at least one greater than S. In a fourth of the shaped conductors, the increment is at least one smaller than S. The head portion furthermore has an offset portion. The offset portion connects the inner portion to the outer portion. The offset portion has a greater radial extent than the inner portion and the outer portion. The outer portion of the head portion of the third shaped conductor runs at least partially radially further outward than the outer portions of the head portions of the first, the second and the fourth shaped conductor.

The invention is based on the concept of routing the outer portion of the third shaped conductor, i.e. the one with the large increment, radially outside along the outer portions of the first, the second and the fourth shaped conductor, so as to utilize radial installation space. The required offset in the radial direction herein is formed by the offset portion of a respective head portion. A small winding overhang can be achieved on the first end side as a result.

The stator core can be formed from a multiplicity of axially layered and/or mutually electrically isolated individual laminations.

The inner portion and/or outer portion of the head portion of a respective shaped conductor preferably extend/extends in the circumferential direction and in the axial direction. The offset portion of the head portion of a respective shaped conductor preferably forms a radial offset between ends of the inner portion and of the outer portion of the respective shaped conductor that face the offset portion.

The offset portion of the head portion of a respective shaped conductor forms in particular a location of the head portion that is axially furthest away from the stator core. At this location, the axial extent of the offset portion is in particular reversed. A transition from the first leg portion to the inner portion and/or a transition from the inner portion to the offset portion and/or a transition from the offset portion to the outer portion and/or a transition from the outer portion to the second leg portion are/is preferably formed with a bending radius that is smaller than any bend radius occurring on the inner portion and/or outer portion.

The shaped conductors on the side facing away from the head portion can in each case also have two connecting portions which adjoin the leg portions and are disposed on the other end side of the stator core. A respective connecting portion can be connected mechanically and in an electrically conductive manner to the connecting portion of another shaped conductor. Preferably, the connecting portions are connected in a materially integral manner, in particular by means of welding. The leg portions and/or the head portion and/or the connecting portions of a respective shaped conductor can be formed in one piece. The shaped conductors are in each case preferably formed from a rod bent multiple times. The shaped conductors can be formed from a metal, preferably copper.

The shaped conductors have in particular rectangular cross sections with two lateral lengths. The two lateral lengths can be identical, but preferably have different lengths. If, for example, the shaped conductors are bent by way of their longer sides, their bending radii are preferably at least as large as the length of the shorter side lengths. If, for example, the shaped conductors are bent by way of their shorter sides, the bending radii are preferably at least three quarters as large as the length of the longer side lengths.

In preferred design embodiment it is provided that the outer portion of the head portion of the fourth shaped conductor runs at least partially radially further outward than the outer portion of the head portion of the first shaped conductor. As a result, the outer portion of the head portion of the fourth shaped conductor, which has the small increment, can be routed past the outer portion of the first shaped conductor with the increment S in a space-saving manner.

Preferably, each groove is radially divided at least into first to fourth layers, which are sequenced in the order of their designation, for receiving one of the leg portions of one of the shaped conductors. The first layer can be the radially inner layer. In a refinement it can be provided that the first leg portion is disposed in the first or the second layer. Alternatively or additionally, it can be provided that the second leg portion is disposed in the third or the fourth layer.

In detail, it can be provided that
the first leg portion of the first shaped conductor is disposed in the first layer; and/or
the second leg portion of the first shaped conductor is disposed in the third layer; and/or
the first leg portion of the second shaped conductor is disposed in the first layer; and/or
the second leg portion of the second shaped conductor is disposed in the third layer; and/or
the first leg portion of the third shaped conductor is disposed in the second layer; and/or
the second leg portion of the third shaped conductor is disposed in the fourth layer; and/or
the first leg portion of the fourth shaped conductor is disposed in the second layer; and/or
the second leg portion of the fourth shaped conductor is disposed in the fourth layer.

Expediently, it can be provided that the first leg portions of the first and the third shaped conductor are disposed in the same groove, and the first leg portions of the second and the fourth shaped conductor are disposed in the same groove. It is preferable here for the groove in which the first leg portions of the first and the third shaped conductor are disposed, and the groove in which the first leg portions of the second and the fourth shaped conductor are disposed, are directly adjacent. Alternatively or additionally, it is provided that the second leg portions of the first and the fourth shaped conductor are disposed in the same groove, and the second leg portions of the second and the third shaped conductor are disposed in the same groove. It can be provided herein that the groove in which the second leg portions of the first and the fourth shaped conductor are disposed, and the groove in which the second leg portions of the second and the third shaped conductor are disposed, are directly adjacent.

Moreover, in fifth to eighth of the shaped conductors the increment can be S, wherein the first leg portions of the fifth and the sixth shaped conductor can be disposed in the same groove, and the groove can be adjacent to the groove in which the first leg portions of the first and the third shaped conductor are disposed. The first leg portions of the seventh and the eighth shaped conductor can be disposed in the same groove, and the groove can be adjacent to the groove in which the first leg portions of the second and the fourth shaped conductor are disposed. Preferably, it is provided that the head portions of the first to fourth shaped conductors are disposed between the head portions of the fifth and the sixth shaped conductor and the head portions of the seventh and the eighth shaped conductor.

In a first preferred design embodiment of the stator according to the invention, one or a plurality of the following features may be provided:

The circumferential extent of the offset portions of the fifth to eighth shaped conductors is preferably chosen, in particular as a function of a material thickness of the shaped conductors and/or of their bending radii, to be so minor that the outer portion of the head portion of the seventh shaped conductor axially covers the outer portion of the head portion of the third shaped conductor. As a result of the design embodiment of the fifth to eighth shaped conductors, the end windings are widely spread out. As a result of being spread out, a gap into which the first to fourth shaped conductors can be inserted is created between the fifth and the sixth shaped conductor, on the one hand, and the seventh and the eighth shaped conductor, on the other hand. The gap also permits a joining process of a shaped conductor cage that for manufacturing the stator is introduced with the leg portions ahead into the grooves to be kept simple.

The inner portion of the head portion of the first shaped conductor can extend radially further inward than the inner portion of the head portion of the second shaped conductor and/or than the inner portion of the sixth shaped conductor and/or than the inner portion of the eighth shaped conductor. Alternatively or additionally, the inner portion of the head portion of the first shaped conductor can extend radially inward beyond a radially inner delimitation of the grooves, in particular beyond a radially inner shell face of the stator core.

The outer portion of the head portion of the third shaped conductor can extend outward as far as the outer portion of the head portion of the fifth shaped conductor and/or as the outer portion of the head portion of the seventh shaped conductor. The outer portion of the head portion of the third shaped conductor and/or the outer portion of the head portion of the fifth shaped conductor and/or the outer portion of the head portion of the seventh shaped conductor can extend radially outward beyond a radially outer delimitation of the grooves.

It can be provided that the head portions of the fifth and the seventh shaped conductor and/or the head portions of the sixth and the eighth shaped conductor and/or the head portions of the fifth and the second shaped conductor and/or the head portions of the seventh and the second shaped conductor are identically shaped. The variety of shapes of the shaped conductors can be kept to a minimum as a result.

It can furthermore be provided that
the first leg portion of the fifth shaped conductor is disposed in the second layer; and/or
the second leg portion of the fifth shaped conductor is disposed in the fourth layer; and/or
the first leg portion of the sixth shaped conductor is disposed in the first layer; and/or
the second leg portion of the sixth shaped conductor is disposed in the third layer; and/or
the first leg portion of the seventh shaped conductor is disposed in the second layer; and/or
the second leg portion of the seventh shaped conductor is disposed in the fourth layer; and/or
the first leg portion of the eighth shaped conductor is disposed in the first layer; and/or
the second leg portion of the eighth shaped conductor is disposed in the third layer.

Alternatively or additionally, in the first preferred embodiment, it can be provided that the outer portion of the head portion of the second shaped conductor at least partially covers the outer portion of the head portion of the fourth shaped conductor with respect to the end side.

The first preferred embodiment can also be distinguished in that the outer portion of the head portion of the third shaped conductor extends at least partially axially further away from the stator core than the outer portion of the head portion of the fourth shaped conductor and/or than the outer portion of the head portion of the first shaped conductor. Alternatively or additionally, the outer portion of the head portion of the second shaped conductor can at least partially extend axially further away from the stator core than the outer portion of the head portion of the fourth shaped conductor and/or than the outer portion of the head portion of the first shaped conductor. As a result, the space available for the disposal of the first to fourth shaped conductors can be utilized efficiently, and a small winding overhang can be achieved.

Alternatively or additionally, it can be provided that the offset portions of the head portions of the first, the third and the fourth shaped conductor run side by side along an angular region of the circumferential direction that occupies at least half of an angular region of the circumferential direction occupied by the offset portion of the head portion of the first shaped conductor.

In a second preferred design embodiment of the stator according to the invention, one or a plurality of the following features can be provided:

The outer portion of the head portion of the third shaped conductor can run at least in portions radially further outward than the outer portion of the head portion of the fifth shaped conductor and/or than the outer portion of the head portion of the seventh shaped conductor. The radial extent of the end winding toward the inside can be kept small as a result.

The outer portion of the head portion of the second shaped conductor can run at least partially radially further inward than the outer portion of the head portion of the fourth shaped conductor.

Alternatively or additionally, it can be provided that the outer portion of the head portion of the second shaped conductor at least partially covers the outer portion of the head portion of the first shaped conductor with respect to the end side.

In the second design embodiment, the head portions of the first, the second and the sixth shaped conductor can be identically shaped. Alternatively or additionally, the head portions of the fourth and the fifth shaped conductor can be identically shaped.

In a refinement of the stator according to the invention, it can be provided that the first portions of the head portions of the first and the third shaped conductor run radially side by side between the leg portion adjoining them and the offset portion. Alternatively or additionally, the first portions of the head portion of the second and the fourth shaped conductor can run radially side by side between the leg portion adjoining them and the offset portion.

In a preferred design embodiment, the second, the third and the fourth shaped conductor can be disposed radially side by side in a circular sector of the end side of the stator. This enables a particularly low end winding.

In a preferred design embodiment, the shaped conductors form a plurality of strands of the stator winding. The first to fourth shaped conductors herein can belong to the same strand. Preferably, the stator has at least three strands. Each strand herein corresponds to a phase of the stator.

It is furthermore preferable that the shaped conductors for each strand form a first current path and a second current path which is connected in parallel or in series to the first current path, wherein the first to fourth shaped conductors form a shaped conductor assembly in which the third shaped conductor and the fourth shaped conductor are wired in the first current path, and the first shaped conductor and the second shaped conductor are wired in the second current path. In a further refinement, a further corresponding shaped conductor assembly can be provided, in which the third shaped conductor and the fourth shaped conductor are wired in the second current path, and the first shaped conductor and the second shaped conductor are wired in the first current path.

The fifth and the sixth shaped conductor on the one hand, and the seventh and the eighth shaped conductor on the other hand, in particular belong in each case in particular to different strands than the first to fourth shaped conductors.

The object on which the invention is based is furthermore achieved by an electrical machine comprising a stator according to the invention; and a rotor which is rotatably mounted within the stator; wherein the electrical machine is specified to drive a vehicle.

The electrical machine is preferably an, in particular permanently excited, synchronous machine or an asynchronous machine. The vehicle is preferably a battery-electric vehicle (BEV) or a hybrid vehicle.

The object on which the invention is based is furthermore achieved by a vehicle comprising an electrical machine according to the invention.

Further advantages and details of the present invention are derived from the exemplary embodiments described hereunder and by means of the drawings. The latter are schematic illustrations in which:

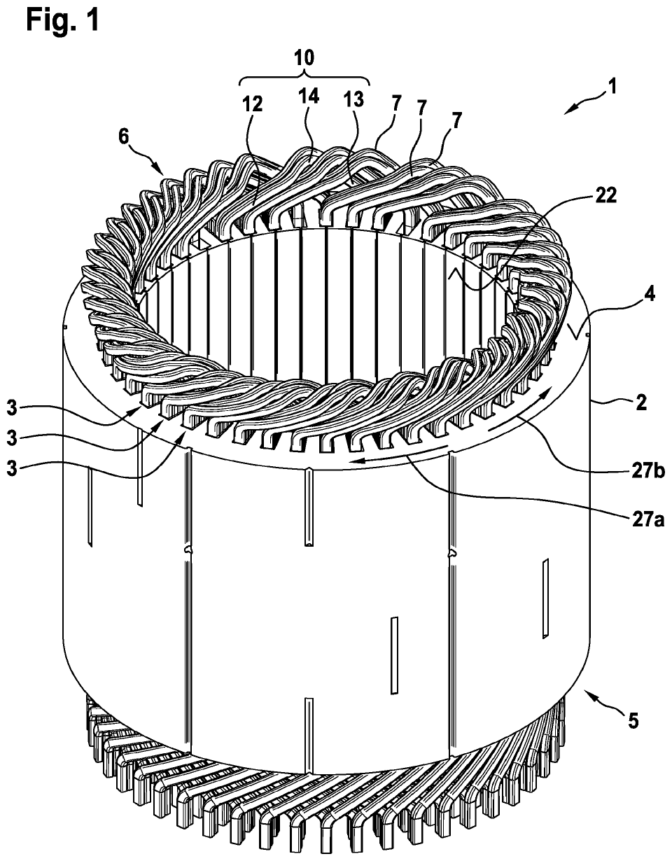

FIG. 1 shows a perspective view of a first exemplary embodiment of the stator according to the invention;

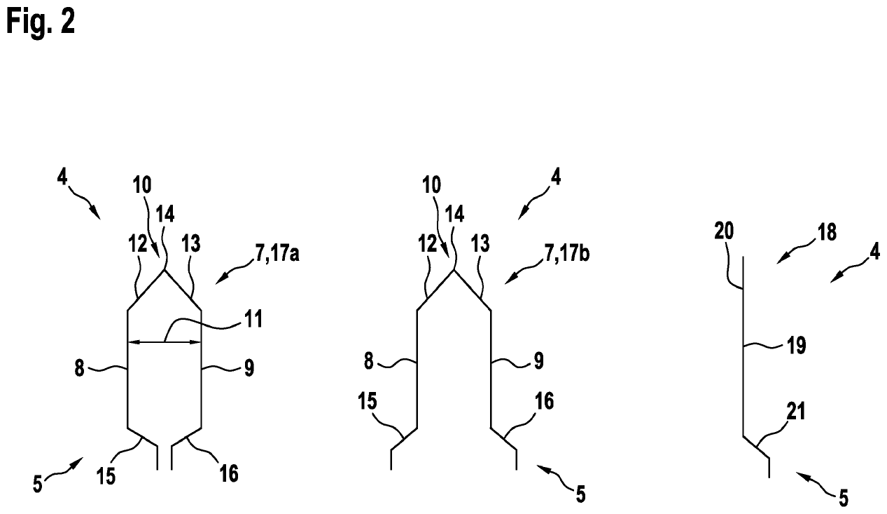

FIG. 2 shows a diagram of the shaped conductors according to the first exemplary embodiment;

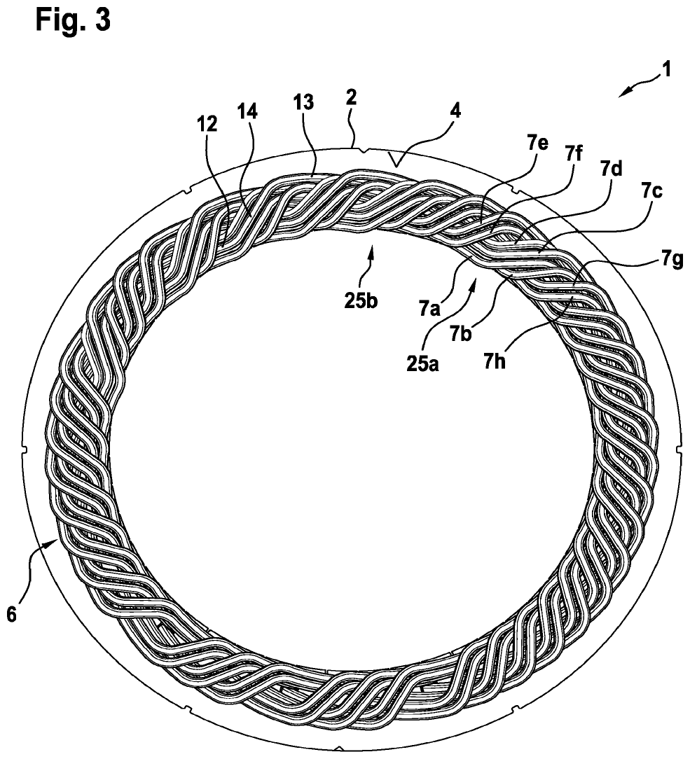

FIG. 3 shows an end-side view of the stator according to the first exemplary embodiment;

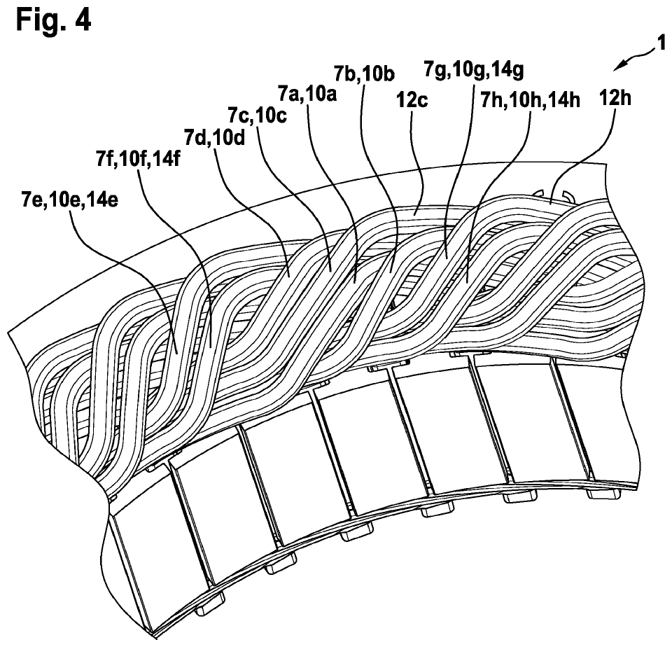

FIG. 4 shows a perspective detailed view of the stator in the region of the first to fourth shaped conductor according to the first exemplary embodiment;

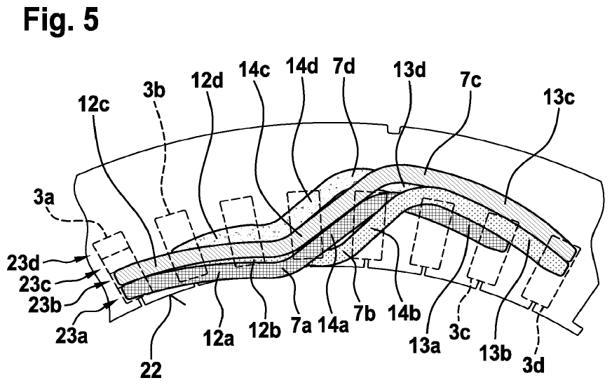

FIG. 5 shows an end-side view of the head portions of the first to fourth shaped conductor according to the first exemplary embodiment;

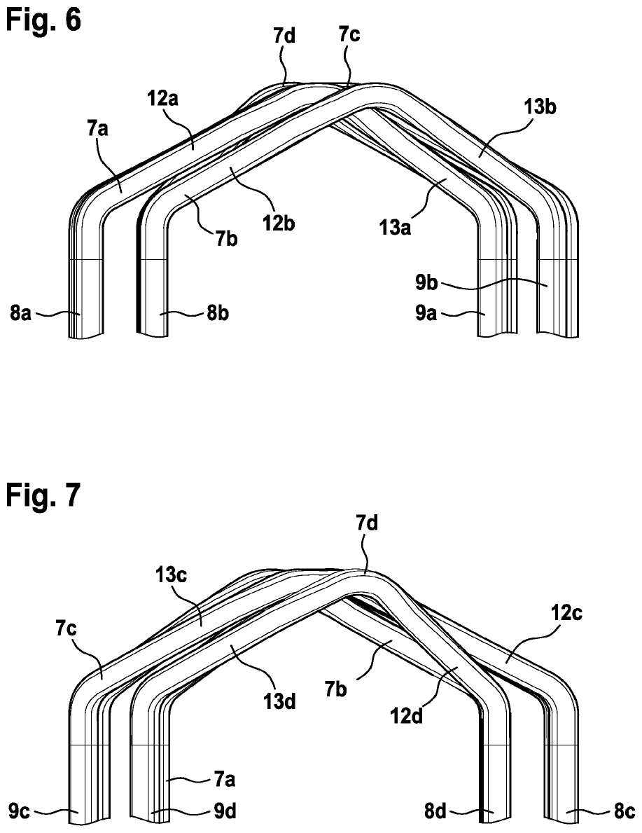

FIG. 6 shows a lateral view from the inside of the head portions of the first to fourth shaped conductor according to the first exemplary embodiment;

FIG. 7 shows a lateral view from the outside of the head portions of the first to fourth shaped conductor according to the first exemplary embodiment;

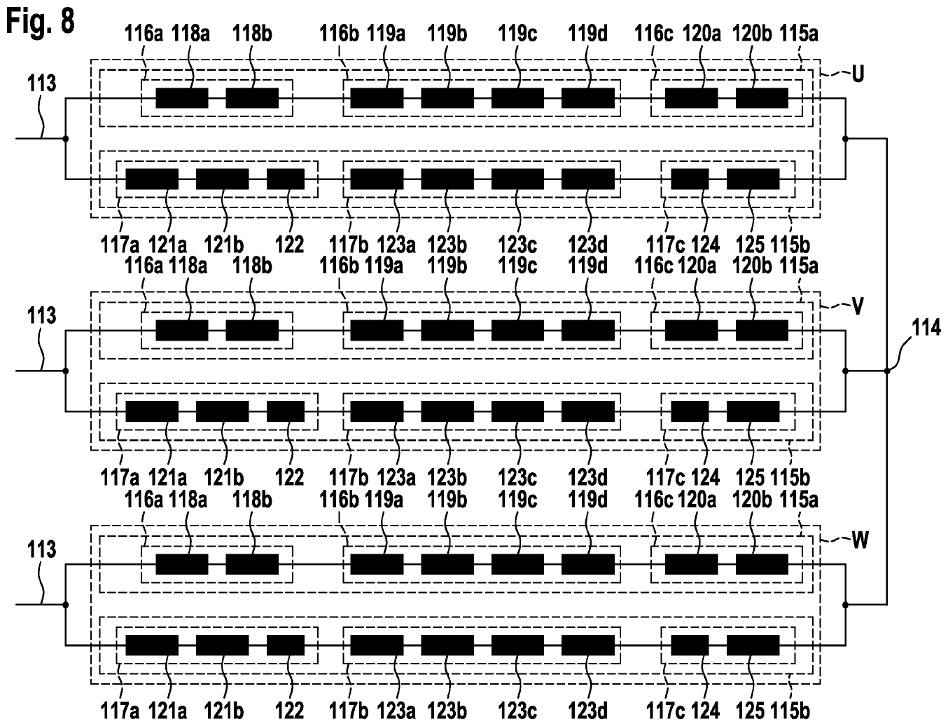

FIG. 8 shows a block diagram of the stator winding of the stator according to the first exemplary embodiment;

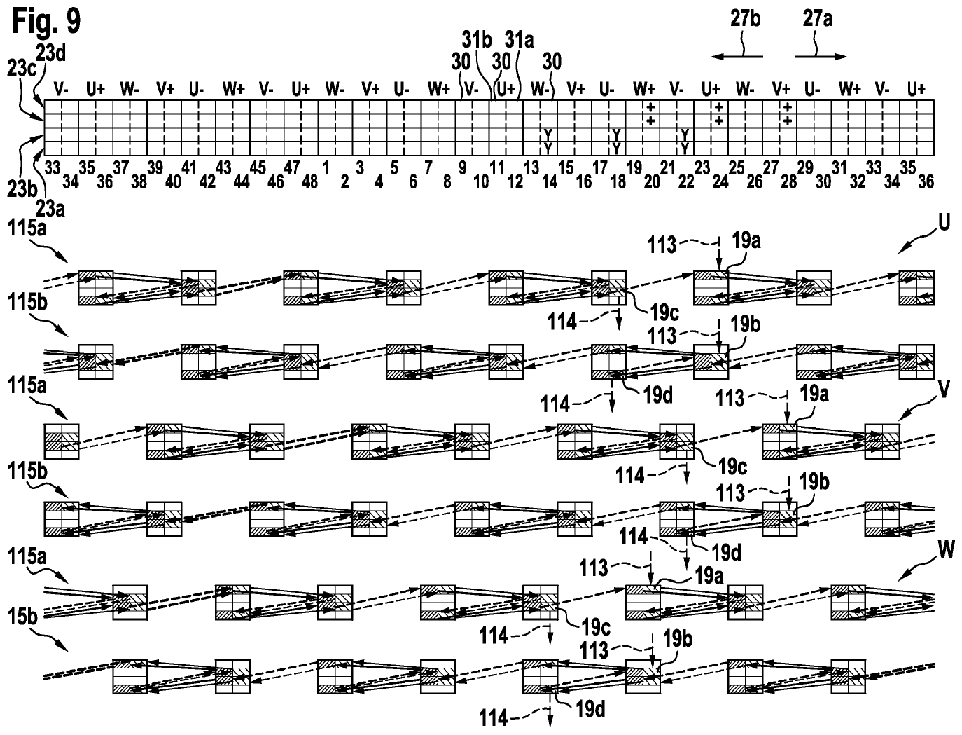

FIG. 9 shows a winding diagram of the stator winding of the stator according to the first exemplary embodiment;

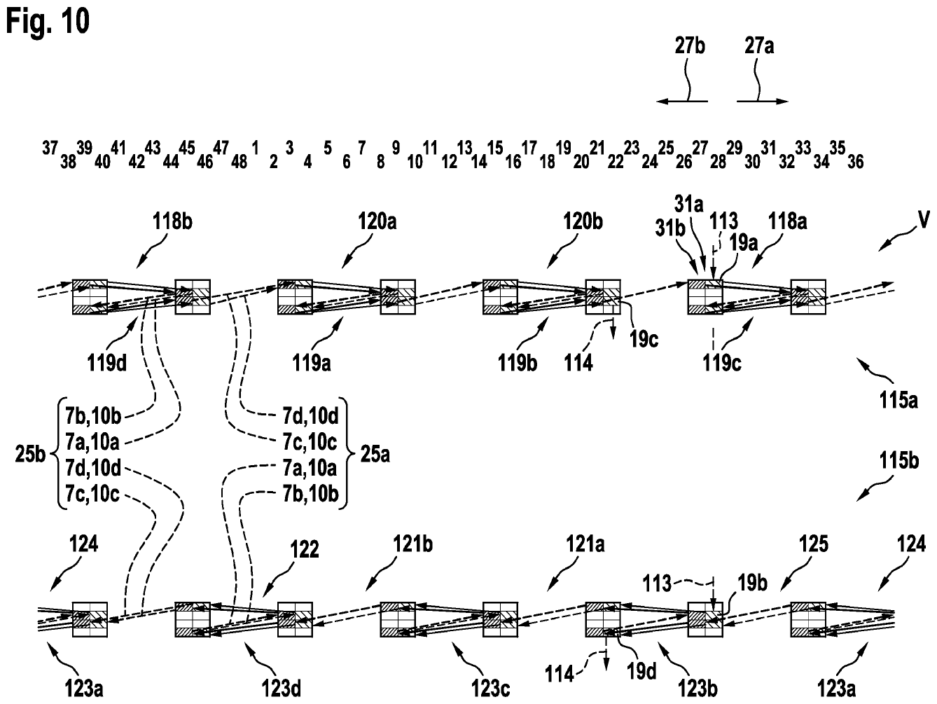

FIG. 10 shows a fragment of the winding diagram, shown in FIG. 9, for a strand according to the first exemplary embodiment;

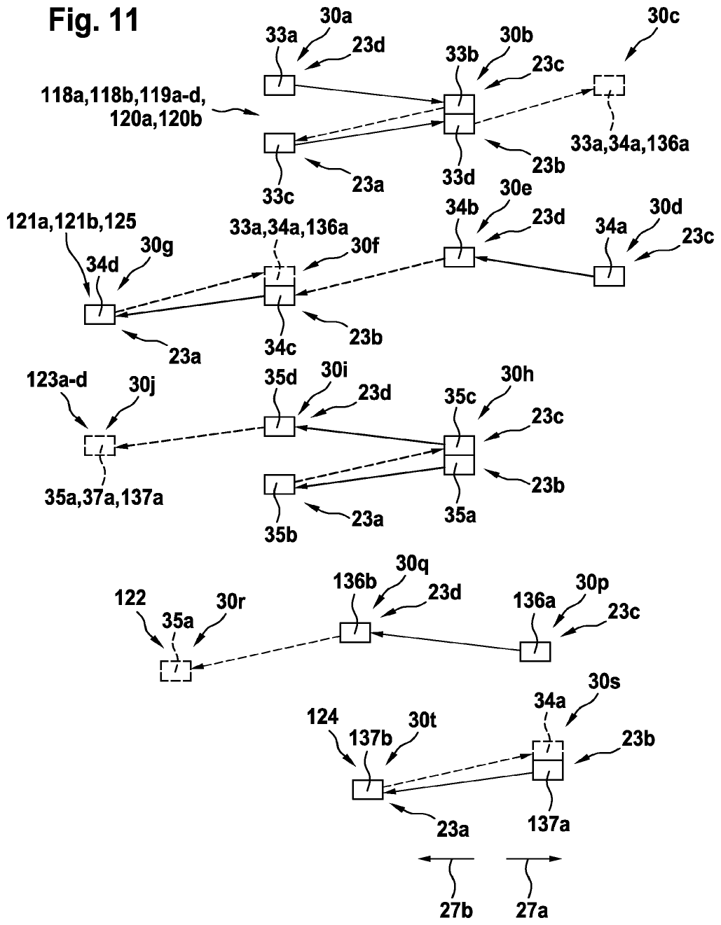

FIG. 11 shows detailed views of the disposal of shaped conductors according to the winding scheme shown in FIG. 9 and according to the first exemplary embodiment;

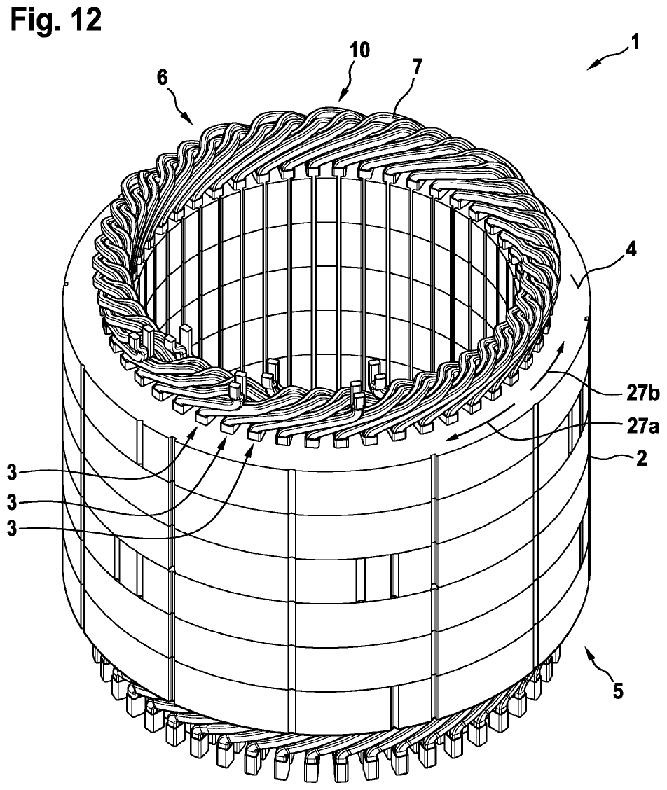

FIG. 12 shows an end-side view of a second exemplary embodiment of the stator according to the invention;

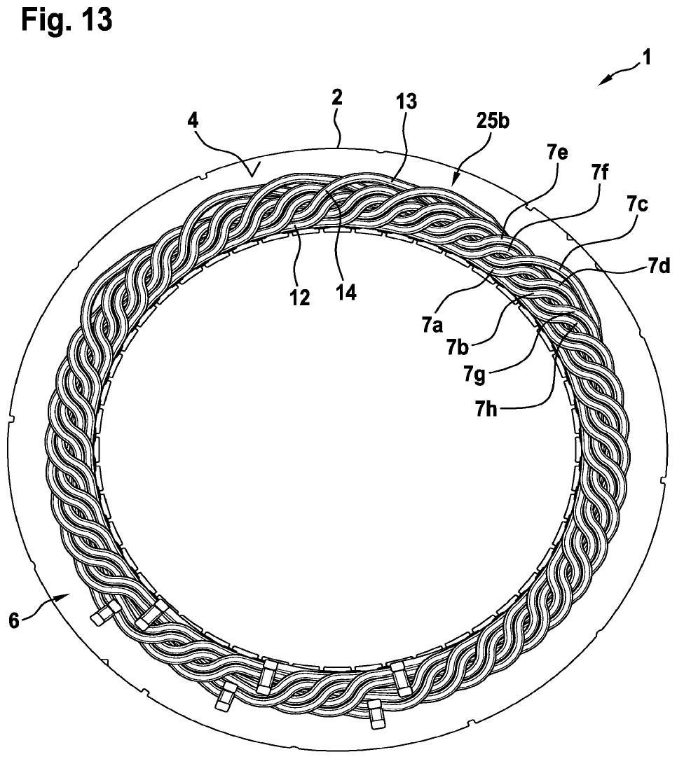

FIG. 13 shows a perspective detailed view of the stator in the region of the first to fourth shaped conductor according to the second exemplary embodiment;

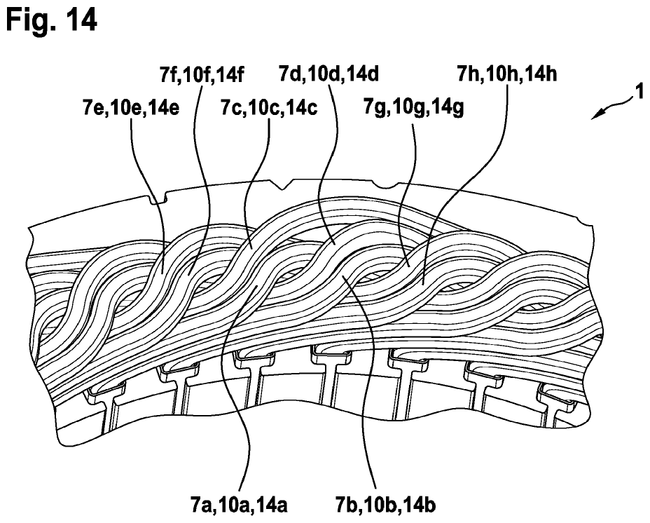

FIG. 14 shows a perspective detailed view of the stator in the region of the first to fourth shaped conductor according to the first exemplary embodiment;

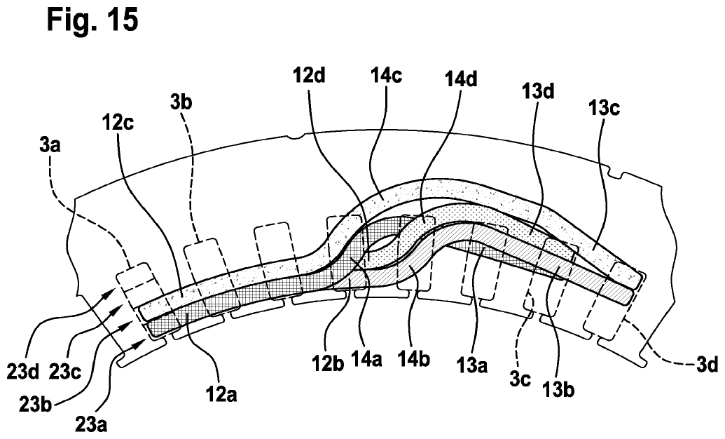

FIG. 15 shows an end-side view of the head portions of the first to fourth shaped conductor according to the second exemplary embodiment;

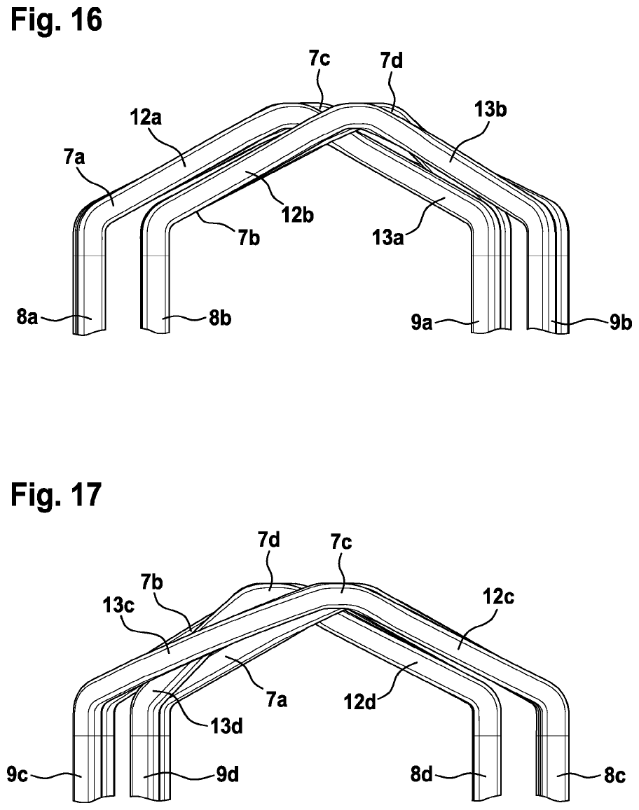

FIG. 16 shows a lateral view from the inside of the head portions of the first to fourth shaped conductor according to the second exemplary embodiment;

FIG. 17 shows a lateral view from the outside of the head portions of the first to fourth shaped conductor according to the second exemplary embodiment; and

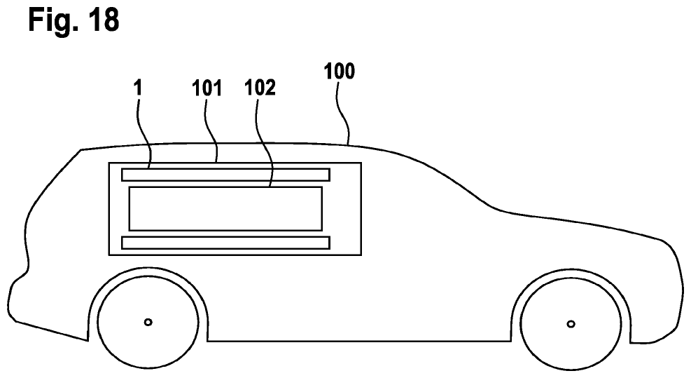

FIG. 18 shows a diagram of an exemplary embodiment of the vehicle according to the invention having an exemplary embodiment of the electrical machine according to the invention.

FIG. 1 is a perspective view of a first exemplary embodiment of a stator 1.

The stator 1 has a stator core 2, in which are formed a plurality of grooves 3 that are distributed along a circumferential direction. The stator core 2 has a first end side 4 and, opposite thereto, a second end side 5. The stator core by way of example is formed from a multiplicity of axially layered and mutually insulated individual laminations and can therefore also be referred to as a laminated stator pack. Moreover, the stator 1 has a stator winding 6, which has a multiplicity of shaped conductors 7. Accordingly, the stator winding can also be referred to as a hair pin winding.

FIG. 2 is a diagram of the shaped conductors 7 according to the first exemplary embodiment.

The shaped conductors 7 have in each case one first leg portion 8, one second leg portion 9 and one head portion 10 which connects the leg portions 8, 9 in an electrically conductive manner on the first end side 4. The leg portions 8, 9 of a respective shaped conductor 7 extend through different grooves 3 (see FIG. 1) and are spaced apart from one another by an increment of a number of grooves. The increment is illustrated by a double arrow 11 in FIG. 2.

The head portion 10 has an inner portion 12 which adjoins the first leg portion 8. Moreover, the head portion 10 has an outer portion 13 which adjoins the second leg portion 9. The head portion 10 furthermore has an offset portion 14 which connects the inner portion 12 to the outer portion 13.

Moreover, the shaped conductor 7 on that side that faces away from the head portion has connecting portions 15, 16 which adjoin the leg portions 8, 9. The connecting portions 15, 16 are disposed on the second end side 5 of the stator core 2. A respective connecting portion 15 is mechanically connected to the connecting portion 16 of another shaped conductor 7 in an electrically conductive and materially integral manner by welding. By way of example, the leg portions 8, 9, the head portion 10 and the connecting portions 15, 16 herein are formed in one piece from a copper rod bent multiple times.

Furthermore shown in FIG. 2 are a first shaped conductor structure 17a and a second shaped conductor structure 17b, which differ from one another in that the connecting portions 15, 16 point toward one another in the first shaped conductor structure 17a, but point away from one another in the shaped conductor structure 17b.

FIG. 2 furthermore shows a shaped terminal conductor 18 of the stator winding 6. The shaped terminal conductor 18 has a leg portion 19 which extends through one of the grooves 3 (see FIG. 1), a terminal portion 20 which adjoins said leg portion 19 on the first end side 3, and a connecting portion 21 which adjoins the leg portion 19 on the second end side 5. The connecting portion 21 is connected to a connecting portion 15, 16 of one of the shaped conductors 7. The terminal portion 20 is used to connect the outer ends of the stator winding 6 (see FIG. 1).

FIG. 3 is an end-side view of the stator 1 according to the first exemplary embodiment.

As can be derived from FIG. 3, the inner portion 12 and the outer portion 13 of a respective shaped conductor 7 extend in the circumferential direction, whereby the outer portion 13 is disposed radially further outward than the inner portion 12. The offset portion 14 has a greater radial extent than the inner portion 12 and the outer portion 13. As can be seen when viewed in combination with FIG. 1, the inner and outer portions 12, 13 extend in the axial direction away from the stator core 2. The offset portion 14 of the head portion 10 of a respective shaped conductor 7 forms a location of the head portion 10 that is axially furthest away from the stator core 2.

FIG. 3 furthermore shows that the shaped conductors 7 comprise a first shaped conductor 7a, a second shaped conductor 7b, a third shaped conductor 7c and a fourth shaped conductor 7d. Moreover, a fifth shaped conductor 7e, a sixth shaped conductor 7f, a seventh shaped conductor 7g and an eighth shaped conductor 7h are indicated in FIG. 3. In the following, the leg portions 8, 9, the head portion 10, the inner portion 12, the outer portion 13, the offset portion 14 and the connecting portions 15, 16 of a respective more precisely designated shaped conductor 7a to 7h are identified by the same lower-case letter as the shaped conductor 7a to 7h.

FIGS. 4 to 7 show the first to fourth shaped conductor 7a to 7d, whereby FIG. 4 is a perspective detailed view of the stator in the region of the first to fourth shaped conductor 7a to 7d, FIG. 5 is an end-side plan view, FIG. 6 is its lateral view from the inside, and FIG. 7 is a lateral view from the outside.

The first shaped conductor 7a and the second shaped conductor 7b have in each case an increment S. The third shaped conductor 7c has an increment S+1. The fourth shaped conductor 7d has an increment S-1. In the present exemplary embodiment, S=6 is selected by way of example, so that the increments of the first and the second shaped conductor 7a, 7b are six, the increment of the third shaped conductor 7c is seven, and the increment of the fourth shaped conductor 7d is five. Illustrated in FIG. 5 are the positions of eight grooves 3, 3a, 3b, 3c across which the first to fourth shaped conductors 7a to 7d extend.

The stator 1 is distinguished in particular in that the outer portion 13c runs radially further outward than the outer portions 13a, 13b, 13d, as is best seen in FIG. 5. Likewise, the outer portion 13d (in FIG. 5 partially obscured by the second shaped conductor 7b) runs radially further outward than the outer portion 13a. When viewed from the first end side, the outer portion 13c is the radially outermost portion of the outer portions 13a to 13d, and the outer portion 13a is the innermost portion of the outer portions 13a to 13d.

It can furthermore be seen in FIG. 5 that the outer portions 13b to 13d extend in each case radially outward beyond an outer radial delimitation of the grooves 3. Moreover, the inner portion 12a extends radially inward beyond an inner shell face 22 of the stator core 2 (see FIG. 1). The outer portion 13b covers the outer portion 13d with respect to the first end side 4. Moreover, the inner portion 12c covers the inner portion 12b with respect to the first end side 4. The offset portions 14a, 14c, 14d of the head portions 10a, 10c, 10d of the first, the third and the fourth shaped conductor 7a, 7c, 7d run side by side along an angular region of the circumferential direction, which occupies at least half of an angular region of the circumferential direction occupied by the offset portion 14a.

As can be derived in particular from FIG. 6 and FIG. 7, the outer portion 13b runs at least partially axially further away from the stator core 2 than the outer portion 13d and than the outer portion 13a. Likewise, the outer portion 13b runs axially further away from the stator core 2 than the outer portion 13d and than the outer portion 13a.

FIGS. 6 and 7 show in detail that the first leg portions 8a, 8c of the first and the third shaped conductor 7a, 7c are disposed in the same groove 3a, and the first leg portions 8b, 8d of the second and the fourth shaped conductor 7b, 7d are disposed in the same groove 3b. The groove 3b is directly adjacent to the groove 3a in the circumferential direction Furthermore, the second leg portions 9a, 9d of the first and the fourth shaped conductor 7a, 7d are disposed in the same groove 3c, and the second leg portions 9b, 9c are disposed in the same groove 3d. The groove 3d is directly adjacent to the groove 3c in the circumferential direction

Moreover, each groove 3 is divided radially into first to fourth layers 23a to 23d, which are sequenced in the order of their designation from the inside to the outside, for receiving one of the leg portions 8, 9 of one of the shaped conductors 7. In the present exemplary embodiment, in the first shaped conductor 7a, the first leg portion 8a is disposed in the first layer 23a, and the second leg portion 9a is disposed in the third layer 23c. In the second shaped conductor 7b, the first leg portion 8b is disposed in the first layer 23a, and the second leg portion 9b is disposed in the third layer 23c. In the third shaped conductor 7c, the first leg portion 8c is disposed in the second layer 23b, and the second leg portion 9c is disposed in the fourth layer 23d. In the fourth shaped conductor 7d, the first leg portion 8d is disposed in the second layer 23b, and the second leg portion 9d is disposed in the fourth layer 23d.

FIG. 4 furthermore shows the fifth to eighth shaped conductors 7e to 7h, which have in each case the increment S. The first leg portions 8e, 8f of the fifth and the sixth shaped conductor 7e, 7f are disposed in the same groove 3 adjacent to the groove 3a in which the first leg portions 8a, 8c are disposed. The first leg portions 8g, 8h of the seventh and the eighth shaped conductor 7g, 7h are disposed in the same groove 3 adjacent to the groove 3b in which the first leg portions 8b, 8d are disposed. Furthermore, the first leg portions 8e, 8h of the fifth and the seventh shaped conductor 7e, 8h are disposed in the second layer 23b, and the first leg portions 8f, 8g of the sixth and the eighth shaped conductor 7f, 7g are disposed in the first layer 23a. The second leg portions 9e, 9h of the fifth and the seventh shaped conductor 7e, 8h are disposed in the fourth layer 23d, and the second leg portions 9f, 9g of the sixth and the eighth shaped conductor 7f, 7g are disposed in the third layer 23c.

The head portions 10a to 10d of the first to fourth shaped conductors 7a to 7d are disposed between the head portions 10e, 10f of the fifth and the sixth shaped conductor 7e, 7f and the head portions 10g, 10h of the seventh and the eighth shaped conductor 7g, 7h.

As can be seen in FIG. 4, the circumferential extent of the offset portions 14e to 14h of the fifth to eighth shaped conductors 7e to 7h is chosen as a function of a material thickness of the shaped conductors 7 and their bending radii to be so minor that the outer portion 12h of the head portion 10h of the seventh shaped conductor 7h axially covers the outer portion 12c of the head portion 10c of the third shaped conductor 7c. As a result of this configuration of the fifth to eighth shaped conductors 7e to 7h, these are spread out to form a gap between the fifth and the sixth shaped conductor 7e, 7f on the one hand, and the seventh and the eighth shaped conductor 7g, 7h on the other hand, into which the first to fourth shaped conductors 7a to 7d can be inserted. The gap also permits a joining process of a shaped conductor cage that for manufacturing the stator 1 is introduced with the leg portions 8, 9 ahead into the grooves 3 to be kept simple.

FIG. 8 is a block diagram of the stator winding of the stator 1 according to the first exemplary embodiment.

In the exemplary configuration shown, the stator 1 has N=3 phases U, V, W and P=4 pole pairs and a hole count q=2. For each phase U, V, W, the shaped conductors 7 form a first current path 115a and a second current path 115b. The current paths 115a, 115b of a respective phase U, V, W are connected in parallel. Alternatively, a connection of the current paths 115a, 115b in series is also possible. The shaped conductors 7 of a respective current path 115a, 115b are connected in series. For each of the phases U, V, W, the current paths 115a, 115b are constructed as follows:

The shaped conductors 7 of the first current path 115a form a first portion 116a, a second portion 116b and a third portion 116c in the order of a phase connection 113 to a star point 114. Likewise, the shaped conductors 7 of the second current path 115b form a first portion 117a, a second portion 117b and a third portion 117c in the sequence from the phase connection 113 to the star point 114.

The shaped conductors 7 of the first portion 116a of the first current path 115a form first to [(P/2)^{th}] groups of a first type 118a, 118b of leg portions 8, 9 connected in series, here form a first group of the first type 118a and a second group of the first type 118b. The shaped conductors 7 of the second portion 116b of the first current path 115a form first to P^{th} groups of a second type 119a-d of leg portions 8, 9 connected in series, here a first group of the second type 119a, a second group of the second type 119b, a third group of the second type 119c and a fourth group of the second type 119d. The shaped conductors 7 of the third portion 116c of the first current path 115a form first to [(P/2) ^{th}] groups of a first type 120a, 120b of leg portions 8, 9 connected in series, here a first group of the first type 120a and a second group of the first type 120b.

The shaped conductors 7 of the first portion 117a of the second current path 115b form first to [(P/2) ^{th}] groups of a second type 121a, 121b of leg portions connected in series 8, 9, here a first group of the second type 121a and a second group of the second type 121b, and a half-group of the first type 122 which on the side thereof facing away from the second portion 117b is connected in series to the groups of the second type 121a, 121b. The shaped conductors 7 of the second portion 117b of the second current path 115b form first to P^{th} groups of a third type 123a-d of leg portions 8, 9 connected in series, here a first group of the third type 123a, a second group of the third type 123b, a third group of the third type 123c and a fourth group of the third type 123d. The shaped conductors 7 of the third portion 117c of the second current path 115a form a half-group of a second type 124 as well as first to [(P/2-1) ^{th}] groups of a second type 125 of leg portions 8, 9 connected in series, here a (first) group of the second type 125 which on the side thereof facing the second portion 117b is connected in series to the half-group of the second type 124.

The portions 116a-c, 117a-c and the groups of first, second and third types 118a, 118b, 119a-d, 120a, 120b, 121a, 121b, 123a-d, 125 herein are denoted in their respective order in terms of the series connection, here counted from the phase connection 113 to the star point 114.

FIG. 9 is a winding diagram of the stator winding of the stator according to the first exemplary embodiment. FIG. 10 is a fragment of the winding diagram shown in FIG. 9 for a strand V according to the first exemplary embodiment.

The stator 1 has a total of 2·P·N·q=48 grooves 3. The hole count q therefore describes the ratio of the number of grooves 3 to the product resulting from the number of poles 2·P and the number of phases N.

Each layer 23a to 23d of a respective groove 3 forms a receptacle space for exactly one leg portion 8, 9, 19. This results in a total number of 2·P·N·q·L=192 receptacle spaces or leg portions 8, 9, 19 of the stator 1, where L describes the number of layers 23a to 23d.

FIG. 9, by way of two arrows disposed above the upper table, shows a first circumferential direction 27a which, when viewed from the first end side 7 of the stator 1, corresponds to the clockwise direction, and the second circumferential direction 27b which, when viewed from the first end side 7 of the stator 1, corresponds to the counterclockwise direction (see also FIG. 1). FIG. 9 furthermore shows a groove numbering from 1 to 48 below the upper table. The upper table in FIG. 9 shows to which strand U, V, W a leg portion 8, 9, 19 disposed in a respective receptacle space belongs, whereby a direction of an electric current through the corresponding leg portion 8, 9, 19 is identified by the suffix “+” or “−”, respectively.

Furthermore, receptacle spaces for a leg portion 19a of a first shaped terminal conductor 18 of a respective first current path 115a, and for a leg portion 19b of a first shaped terminal conductor 18 of a respective second current path 115b, are marked with “+” in the upper table. The leg portions 19a, 19b are connected to the phase connection 113. Moreover, receptacle spaces for a leg portion 19c of a second shaped terminal conductor 18 of a respective first current path 115a, and for a leg portion 19d of a second shaped terminal conductor 18 of a respective second current path 115b in terms of the series connection, are marked with “Y”. The leg portions 19c, 19d are connected to the star point 114. The leg portions 19a to 19d are the outer leg portions of the current paths 115a, 115b in terms of the series connection.

As can be seen, the shaped conductors of each phase U, V, Ware disposed in 2·P=8 winding zones 30 which comprise in each case precisely q·L=8 receptacle spaces. Each winding zone 30 is subdivided into q=2 sub-winding zones 31a, 31b. In each winding zone 30, the first sub-winding zone 31a follows the second sub-winding zone 31b along the first circumferential direction 27a. Each sub-winding zone 31a, 31b extends over all four layers 23a to 23d. In the present exemplary embodiment, each sub-winding zone 31a, 31b by way of example is in exactly one groove 3.

Between the receptacle spaces or the leg portions 8, 9, 19, the head portions 10 are marked with dashed arrows and the connecting portions 15, 16 with solid arrows.

The shaped conductors of a respective current path 115a, 115b form a combined lap and wave winding.

The illustration of the shaped conductors 7 and of the head portions for phase V is representative of the remaining phases U, W, in which the disposal of the shaped conductors 7 corresponds to that of phase V, except for a displacement of q=2 grooves 3. The structure of the stator winding will be explained hereunder by means of phase V.

FIG. 10 is a detailed view of the winding diagram for phase V.

In the first current path 15a, the leg portions 8, 9, 19a of the first portion 116a, i.e. those of the groups of the first type 118a, 118b, and the leg portions 8, 9 of the third portion 31c, i.e. those of the groups of the first type 120a, 120b, are in each case disposed in the first sub-winding zone 116a. The leg portions 8, 9 of the second portion 116b, i.e. those of the groups of the second type 119a-d, are disposed in the second sub-winding zone 31b. In the second path 115b, the leg portions 8, 9, 19b of the first portion 117a, i.e. those of the groups of the second type 121a, 121b and the half-group of the first type 122, and the leg portions 8, 9, 19d of the third portion 117c, i.e. the half-group of the second type 124 and the group of the second type 125, are disposed in the first sub-winding zone 31a. The leg portions 8, 9 of the second portion 117b, i.e. those of the groups of the third type 123a-d, are in each case disposed in the second sub-winding zone 31b. The leg portions 19a, 19b of the first shaped terminal conductor 18 of the first and the second path 15a, 15b are disposed in the same sub-winding zone 31a, and the leg portions 19c, 19d of the second shaped terminal conductor 18 of the first and the second current path 115a, 115b are disposed in the same sub-winding zone 31b. Here, the leg portions 19a, 19b are disposed in the first sub-winding zone 31a, while the leg portions 19c, 19d are disposed in the second sub-winding zone 31a.

The current paths 115a, 115b extend along different circumferential directions 27a, 27b. Here, the first current path 115a extends along the first circumferential direction 27a and the second current path 115b along the second circumferential direction 27b. Within a respective current path 115a, 115b, the first to third portions 116a-c, 117a-c extend along the same circumferential direction 27a, 27b.

In the strand V, the first to fourth shaped conductors 7a to 7b form a first shaped conductor assembly 25a, in which the third shaped conductor 7a and the fourth shaped conductor 7b are wired in the first current path 115a, and the first shaped conductor 7a and the second shaped conductor 7b are wired in the second current path 115. Provided in the strand V is a second corresponding shaped conductor assembly 25b in which the first shaped conductor 7a and the second shaped conductor 7b are wired in the first current path 115a, and the third shaped conductor 7c and the fourth shaped conductor 7d are wired in the second current path 115b. Accordingly, a first shaped conductor assembly 25a and a second shaped conductor assembly 25b are also provided in the other strands U, W.

FIG. 11 is a detailed illustration of the groups 118a, 118b, 119a-d, 120a, 120b, 121a, 121b, 123a-d and 125 and half-groups 122, 124 of leg portions 8, 9, 19 according to the first exemplary embodiment.

The groups of the first type 118a, 118b, 119a-d, 120a, 120b comprise four consecutive leg portions 8, 9, 19 in terms of the series connection, which are separately designated and numbered with 33a-d. Furthermore, three adjacent winding zones 30 are separately designated with 30a-c. In the groups of the first type 118a, 118b, 119a-d, 120a, 120b, a first leg portion 33a is disposed in the fourth layer 23d of one of the winding zones 30a. A second leg portion 33b is disposed in the third layer 23c of a winding zone 30b which along the first circumferential direction 27a is adjacent to the winding zone 30a in which the first leg portion 33a is disposed. A third leg portion 33c is disposed in the first layer 23d of the winding zone 30a, in which the first leg portion 33a is disposed. A fourth leg portion 33d is disposed in the second layer 23b of the winding zone 30b, in which the second shaped conductor 33b is disposed.

The groups of the second type 121a, 121b, 125 comprise four consecutive leg portions 8, 9, 19 in terms of the series connection, which are separately designated and numbered with 34a to 34d. Furthermore, four adjacent winding zones 30 are separately designated with 30d-g in FIG. 11. In the groups of the second type 121a, 121b, 125, a first leg portion 34a is disposed in the third layer 23c of one of the winding zones 30d. A second leg portion 34b is disposed in the fourth layer 23d of a winding zone 30e which along the second circumferential direction 27b is adjacent to the winding zone 30d in which the second leg portion 34a is disposed. A third leg portion 34c is disposed in the second layer 23b of a winding zone 30f which along the second circumferential direction 27b is adjacent to the winding zone 30e in which the second leg portion 34b is disposed. A fourth leg portion 34d is disposed in the first layer 23a of a winding zone 30g which along the second circumferential direction 27b is adjacent to the winding zone 30f in which the third leg portion 34c is disposed.

The groups of the third type 123a-d comprise four consecutive leg portions in terms of the series connection, which are separately designated and numbered with 35a-d. Furthermore, three adjacent winding zones 30 are separately designated with 30h to 30j in FIG. 11. In the groups of the third type 123a-d, a first leg portion 35a is disposed in the second layer 23b of one of the winding zones 30h. A second leg portion 35b is disposed in the first layer 23a of a winding zone 30i which along the second circumferential direction 27b is adjacent to the winding zone 30h in which the first leg portion 35a is disposed. A third leg portion 35c is disposed in the third layer 23c of the winding zone 30h in which the first leg portion 35a is disposed. A fourth leg portion 35d is disposed in the fourth layer 23d of the winding zone 30i in which the second leg portion 35b is disposed.

The half-group of the first type 122 comprises two consecutive leg portions in terms of the series connection, which are separately designated and numbered with 136a, 136b. Furthermore, three adjacent winding zones 30 are separately designated with 30p to 30r in FIG. 11. In the half-group of the first type 122, a first leg portion 136a is disposed in the third layer 23c of one of the winding zones 30p. A second leg portion 136b is disposed in the fourth layer 23d of a winding zone 30q which along the second circumferential direction 27b is adjacent to the winding zone 30p in which the second leg portion 136a is disposed.

The half-group of the second type 124 comprises two consecutive leg portions in terms of the series connection, which are separately designated and numbered with 137a, 137b Furthermore, in FIG. 11, two adjacent winding zones 30 are separately designated with 30s, 30t. In the half-group of the second type 124, a first leg portion 137a is disposed in the second layer 23b of one of the winding zones 30s. A second leg portion 137b is disposed in the first layer 23a of a winding zone 30t which along the second circumferential direction 27b is adjacent to the winding zone 30s in which the first leg portion 137a is disposed.

The first leg portion 33a of such groups of the first type 118b, 119a-d, 120a, 120b which, in terms of the series connection, immediately follow a fourth leg portion 33d of another of the groups of the first type 118a, 118b, 119a-d, 120a, is disposed in that winding zone 30c that along the first circumferential direction 27a follows the winding zone 30b in which the fourth leg portion 33d is disposed.

The first leg portion 34a of such groups of the second type 121b which, in terms of the series connection, immediately follow a fourth leg portion 34d of another of the groups of the second type 121a, is disposed in that winding zone 30f in which the third leg portion 34c of the other group of the second type 121a is disposed.

The first leg portion 35a of that group of the third type 123a that, in terms of the series connection, immediately follows the second leg portion 136b of the half-group of the first type 122, is disposed in that winding zone 30r that along the second circumferential direction 27b follows the winding zone 30q in which the second leg portion 136b of the half-group of the first type 122 is disposed.

The first leg portion 137a of the half-group of the second type 124 is disposed in that winding zone 30j that along the second circumferential direction 27b follows the winding zone 30i in which the fourth leg portion of the group of the third type 123d is disposed.

The first leg portion 34a (see FIG. 10) of that group of the second type 125 that, in terms of the series connection, immediately follows the second leg portion 137b of the half-group of the second type 124, is disposed in that winding zone 30s in which the first leg portion 137a of the half-group of the second type 124 is disposed.

FIG. 12 to FIG. 17 show a second exemplary embodiment of a stator 1. The illustration in FIG. 12 corresponds to that in FIG. 1, and the illustrations in FIG. 13 to FIG. 17 correspond to those in FIG. 3 to FIG. 7. Unless otherwise mentioned hereunder, all embodiments pertaining to the first exemplary embodiment can be applied to the stator 1 according to the second exemplary embodiment. The same or equivalent components are provided with identical reference signs herein.

In the second exemplary embodiment, the outer portion 13c runs at least in portions radially further outward than the outer portion 13e of the head portion 10e of the seventh shaped conductor 7e, and than the outer portion 13g of the head portion 10g of the seventh shaped conductor 7g. The outer portion 13b runs at least partially radially further inward than the outer portion 13d. The outer portion of the head portion 13b at least partially covers the outer portion 13a with respect to the end side 4.

Moreover, in the second exemplary embodiment, the head portions 10a, 10b, 10f of the first, the second and the sixth shaped conductor 7a, 7b, 7f are identically shaped. Likewise, the head portions 10d and 10e of the fourth and the fifth shaped conductor 7d, 7e are identically shaped.

FIG. 18 is a diagram of an exemplary embodiment of a vehicle 100 having an exemplary embodiment of an electrical machine 101.

The electrical machine 101 comprises a stator 1 according to one of the embodiments described above, and a rotor 102 which is mounted so as to be rotatable relative to the stator 1. The electrical machine 101 is a permanently excited synchronous machine, a synchronous reluctance machine or an asynchronous machine/induction machine and is specified to drive the vehicle 100. The vehicle 100 is a battery-electric vehicle or a hybrid vehicle.

1. A stator for an electrical machine, having a stator core, in which are formed a multiplicity of grooves that are distributed along a circumferential direction, and which has two end sides that are mutually opposite in an axial direction, and a stator winding that has a multiplicity of shaped conductors, wherein
the shaped conductors have in each case one first leg portion, one second leg portion and one head portion which connects the leg portions in an electrically conductive manner on one of the end sides; wherein
the leg portions of a respective shaped conductor extend through different grooves and are spaced apart from one another by an increment of a number of grooves; wherein
the head portion has an inner portion which extends in the circumferential direction and adjoins the first leg portion, and an outer portion which extends in the circumferential direction, adjoins the second leg portion and is disposed radially further outward than the inner portion; wherein
the increment in a first and a second of the shaped conductors is S, in a third of the shaped conductors is at least one greater than S, and in a fourth of the shaped conductors is at least one smaller than S, where S is a natural number,
wherein
in that the head portion furthermore has an offset portion which connects the inner portion to the outer portion and has a greater radial extent than the inner portion and the outer portion; and
in that the outer portion of the head portion of the third shaped conductor runs at least partially radially further outward than the outer portions of the head portions of the first, the second and the fourth shaped conductor.

2. The stator as claimed in claim 1, wherein
the outer portion of the head portion of the fourth shaped conductor runs at least partially radially further outward than the outer portion of the head portion of the first shaped conductor.

3. The stator as claimed in claim 1, wherein
each groove is divided radially at least into first to fourth layers, which are sequenced in the order of their designation, for receiving one of the leg portions of one of the shaped conductors, the first leg portion being disposed in the first or the second layer and/or the second leg portion being disposed in the third or the fourth layer.

4. The stator as claimed in claim 1, wherein
the first leg portions of the first and the third shaped conductor are disposed in the same groove, and the first leg portions of the second and the fourth shaped conductor are disposed in the same groove; and/or
the second leg portions of the first and the fourth shaped conductor are disposed in the same groove, and the second leg portions of the second and the third shaped conductor are disposed in the same groove.

5. The stator as claimed in claim 4, wherein
the groove in which the first leg portions of the first and the third shaped conductor are disposed, and the groove in which the first leg portions of the second and the fourth shaped conductor are disposed, are directly adjacent; and/or
the groove in which the second leg portions of the first and the fourth shaped conductor are disposed, and the groove in which the second leg portions of the second and the third shaped conductor are disposed, are directly adjacent.

6. The stator as claimed in claim 1, wherein
in fifth to eighth of the shaped conductors the increment is S;
the first leg portions of the fifth and the sixth shaped conductor being disposed in the same groove, and the groove being adjacent to the groove in which the first leg portions of the first and the third shaped conductor are disposed;
the first leg portions of the seventh and the eighth shaped conductor being disposed in the same groove, and the groove being adjacent to the groove in which the first leg portions of the second and the fourth shaped conductor are disposed;
the head portions of the first to fourth shaped conductors being disposed between the head portions of the fifth and the sixth shaped conductor and the head portions of the seventh and the eighth shaped conductor.

7. The stator as claimed in claim 6, wherein
the circumferential extent of the offset portions of the fifth to eighth shaped conductors, is chosen, in particular as a function of a material thickness of the shaped conductors and/or of their bending radii, to be so minor that the outer portion of the head portion of the seventh shaped conductor axially covers the outer portion of the head portion of the third shaped conductor.

8. The stator as claimed in claim 1, wherein
the outer portion of the head portion of the second shaped conductor at least partially covers the outer portion of the head portion of the fourth shaped conductor with respect to the end side.

9. The stator as claimed in claim 1, wherein
the outer portion of the head portion of the third shaped conductor runs at least partially axially further away from the stator core than the outer portion of the head portion of the fourth shaped conductor and/or than the outer portion of the head portion of the first shaped conductor.

10. The stator as claimed in claim 1, wherein
the offset portions of the head portions of the first, the third and the fourth shaped conductor run side by side along an angular region of the circumferential direction that occupies at least half of an angular region of the circumferential direction occupied by the offset portion of the head portion of the first shaped conductor.

11. The stator as claimed in claim 6, wherein
the outer portion of the head portion of the third shaped conductor runs at least in portions further radially outward than the outer portion of the head portion of the fifth shaped conductor and/or than the outer portion of the head portion of the seventh shaped conductor.

12. The stator as claimed in claim 1, wherein
the outer portion of the head portion of the second shaped conductor runs at least partially radially further inward than the outer portion of the head portion of the fourth shaped conductor; and/or
the outer portion of the head portion of the second shaped conductor at least partially covers the outer portion of the head portion of the first shaped conductor with respect to the end side.

13. The stator as claimed in claim 1, wherein
the shaped conductors form a plurality of strands of the stator winding, wherein the first to fourth shaped conductors belong to the same strand.

14. The stator as claimed in claim 13, wherein
the shaped conductors for each strand form a first current path and a second current path which is connected in parallel or in series to the first current path, wherein the first to fourth shaped conductors form a shaped conductor assembly in which the third shaped conductor and the fourth shaped conductor are wired in the first current path, and the first shaped conductor and the second shaped conductor are wired in the second current path, wherein provided is a further corresponding shaped conductor assembly in which the third shaped conductor and the fourth shaped conductor are wired in the second current path, and the first shaped conductor and the second shaped conductor are wired in the first current path.

15. An electrical machine comprising a stator as claimed in claim 1; and a rotor which is rotatably mounted within the stator; wherein the electrical machine is specified to drive a vehicle.

16. The stator as claimed in claim 2, wherein
each groove is divided radially at least into first to fourth layers, which are sequenced in the order of their designation, for receiving one of the leg portions of one of the shaped conductors, the first leg portion being disposed in the first or the second layer and/or the second leg portion being disposed in the third or the fourth layer.

17. The stator as claimed in claim 2, wherein
the first leg portions of the first and the third shaped conductor are disposed in the same groove, and the first leg portions of the second and the fourth shaped conductor are disposed in the same groove; and/or
the second leg portions of the first and the fourth shaped conductor are disposed in the same groove, and the second leg portions of the second and the third shaped conductor are disposed in the same groove.

18. The stator as claimed in claim 2, wherein
in fifth to eighth of the shaped conductors the increment is S;
the first leg portions of the fifth and the sixth shaped conductor being disposed in the same groove, and the groove being adjacent to the groove in which the first leg portions of the first and the third shaped conductor are disposed;
the first leg portions of the seventh and the eighth shaped conductor being disposed in the same groove, and the groove being adjacent to the groove in which the first leg portions of the second and the fourth shaped conductor are disposed;
the head portions of the first to fourth shaped conductors being disposed between the head portions of the fifth and the sixth shaped conductor and the head portions of the seventh and the eighth shaped conductor.

19. The stator as claimed in claim 2, wherein
the outer portion of the head portion of the second shaped conductor at least partially covers the outer portion of the head portion of the fourth shaped conductor with respect to the end side.

20. The stator as claimed in claim 2, wherein
the outer portion of the head portion of the third shaped conductor runs at least partially axially further away from the stator core than the outer portion of the head portion of the fourth shaped conductor and/or than the outer portion of the head portion of the first shaped conductor.
